(19) United States
(12) Patent Application Publication
(10) Pub. No.: US 2012/0072438 A1
(43) Pub. Date: Mar. 22, 2012

(54) Generation and Processing of Pick/Put System Configuration and Recipe Data Sets

(76) Inventors: James S. Bast, Hartland, WI (US); Michael S. McManus, Pewaukee, WI (US); John A. Henk, Sussex, WI (US)

(21) Appl. No.: 13/236,078

(22) Filed: Sep. 19, 2011

Related U.S. Application Data
(60) Provisional application No. 61/383,959, filed on Sep. 17, 2010.

(51) Int. Cl. G06F 17/30

(52) U.S. Cl. 707/758; 707/E17.01

(57) ABSTRACT

A format for information that may be used in one or more spreadsheets to enter desired characteristics that may then be shown or activated on one or more pick/put system modules is provided. A method of generating, storing, and later recalling different recipes, and the necessary computer program to cause the modules to respond with the characteristics defined by the recipes is also provided.

### CROSS-REFERENCE TO RELATED APPLICATIONS

This application claims the benefit of U.S. Provisional Patent Application Ser. No. 61/383,959, filed Sep. 17, 2010, and entitled “Generation and Processing of Pick/Put System Configuration and Recipe Programs,” which is hereby incorporated by reference.

### STATEMENT REGARDING FEDERALLY SPONSORED RESEARCH OR DEVELOPMENT

Not applicable.

### FIELD OF THE INVENTION

The present invention relates generally to systems and methods adapted to guide a person through the picking and/or putting of parts, and, more particularly, to the generation and processing of pick/put system data sets including, but not limited to, configuration data sets and recipe data sets.

### BACKGROUND OF THE INVENTION

One general type of picking system is commonly referred to as a “pick to light and put to light system,” or pick/put system for short. Pick/put systems are typically used to guide an operator to locations where items or components are stored and to allow the operator to confirm that the necessary action(s) at that location was completed. The operator typically follows a sequence of steps, and the action at a location may include obtaining an item(s) and/or placing an item(s). These systems typically consist of independent modules, each of which may contain a variety of devices, such as one or more of an indicator light, a button or other device for confirmation of action, and may frequently include a display to indicate a quantity or provide instructions. These modules are typically attached in close proximity to the locations to which they refer. The modules are linked together by a communication method that allows them to operate under the direction of a computer.

These systems generally have several preconfigured methods in which they can operate and are preprogrammed by the system provider (vendor). Alternatively, the system provider may develop a unique method of operation for a specific customer or a specific application using a computer programming language such as Basic or C language. In either case, the system provider programmed method makes use of data provided by a higher level computer (Host), and doesn't allow for an end user to program the system or modify the system.

It would, therefore, be desirable to have a system in which the end user could fully control the system operation and display without relying on a preconfigured method or one uniquely programmed by the system provider. This system should provide a method for generating, storing, and later recalling different recipe data sets defining a sequence of steps using an approach which is familiar and hence easily learned by an end user with limited computer skill. Furthermore, the system may provide a computer program to cause the modules to respond to the characteristics defined by the recipes.

### BRIEF SUMMARY OF THE INVENTION

The present embodiments overcomes the aforementioned drawbacks of the previous preprogrammed systems by allowing the person designing/creating the sequence of steps (also referred to as a recipe) to use a spreadsheet to enter data that defines the sequence of steps the operator will follow, e.g., pick and/or put, including the information and characteristics that each module will display or provide. Embodiments of the invention include a format for information that may be used in the spreadsheet to enter desired characteristics that may then be shown on one or more modules. Embodiments of the invention also include a method of generating, storing, and later recalling different recipes, and the computer program to cause the modules to respond with the characteristics defined by the recipes.

In accordance with one embodiment of the invention, systems and methods are disclosed. A system comprises a computer program stored in a computer memory, the computer program adapted to control one or more modules of a pick/put system by interpreting data stored in a spreadsheet, the data stored in the spreadsheet indicating a sequence of steps associated with the one or more modules of the pick/put system.

In accordance with another embodiment of the invention, an arrangement is provided and comprises at least one pick/put system module associated with at least one physical location. A computer running a spreadsheet program is included, the spreadsheet program includes a configuration data set and a recipe data set, where the computer also runs a control program, the control program adapted to interpret the configuration data set and the recipe data set to control the at least one pick/put system module. The arrangement also includes a network to couple the at least one pick/put system module to the computer.

In accordance with yet another embodiment of the invention, a method is provided and comprises steps of inputting data into a spreadsheet program to create a recipe spreadsheet; providing a computer program stored on a computer, the computer program adapted to interpret the recipe spreadsheet; saving the recipe spreadsheet in memory; initiating the computer program to interpret the recipe spreadsheet; and controlling a pick/put system based on interpreting the recipe spreadsheet.

To the accomplishment of the foregoing and related ends, the embodiments, then, comprise the features hereinafter fully described. The following description and the annexed drawings set forth in detail certain illustrative aspects of the invention. However, these aspects are indicative of but a few of the various ways in which the principles of the invention can be employed. Other aspects, advantages and novel features of the invention will become apparent from the following detailed description of the invention when considered in conjunction with the drawings.

### BRIEF DESCRIPTION OF THE SEVERAL VIEWS OF THE DRAWINGS

The embodiments will hereafter be described with reference to the accompanying drawings, and:

FIG. 1 is a front view of a typical workstation;

FIG. 2 is a schematic view of typical workstation components;

FIG. 3 is a representative view of a sample configuration spreadsheet according to an embodiment of the invention;

FIG. 4 is a representative view of a sample recipe spreadsheet according to an embodiment of the invention; and

FIG. 5 is a flow chart of a computer program showing representative steps for operation in an embodiment of the invention.

### DETAILED DESCRIPTION OF THE INVENTION

The various aspects of the invention will be described in connection with parts picking systems. That is because the features and advantages that arise due to the invention are well suited to this purpose. For this reason, the embodiments herein will be described in the context of generating and processing of pick to light and put to light system data sets including, but not limited to, configuration data sets and recipe data sets. Still, it should be appreciated that the various aspects of the invention can be applied to achieve other objectives as well.

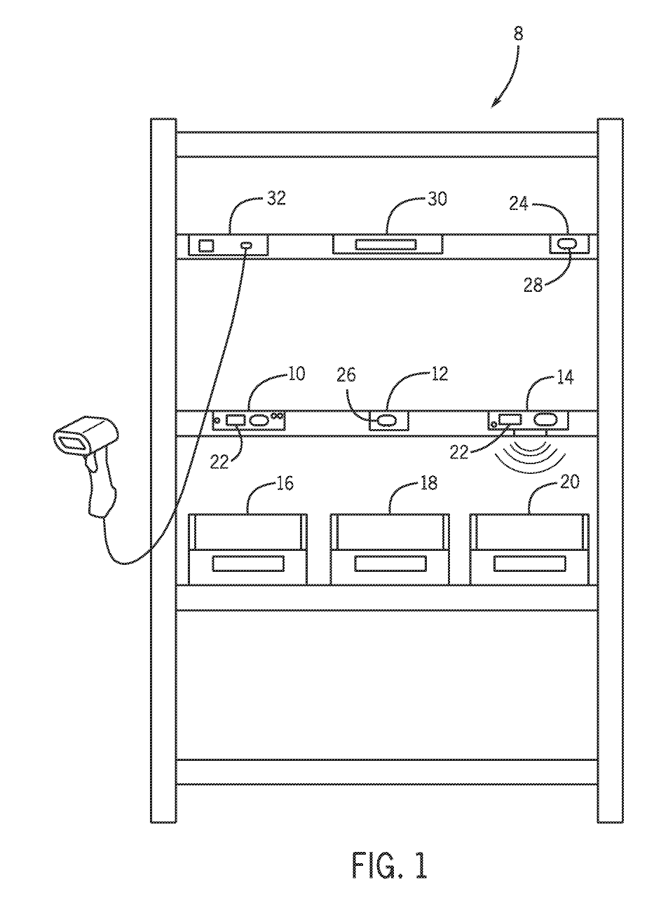

Referring to an exemplary embodiment in more detail, FIG. 1 shows a variety of modules used with pick/put systems that are typically installed on a product storage shelving or an assembly workstation. For example, modules 10, 12 and 14 are positioned to refer to items to be picked from, or put at, physical locations, such as boxes 16, 18 and 20, respectively. It is to be appreciated that any known storage device or technique may be used at or in a physical location. Some modules, such as modules 10 and 14, are shown to contain small displays 22 to indicate a quantity to pick or a simple message or instruction for the operator. Other modules, such as modules 12 and 24, may provide only an indication light 26 and/or push button 28. Module 30 represents one or more alphanumeric display modules that are typically used to provide guidance or instructions as part of the picking and/or putting process. Module 32 may be a bar code reader, which provides the operator with the ability to input (e.g., scan) the part number to identify to the system the part number or build number of the part or order being processed at the station (i.e., the product storage shelving or an assembly workstation).

In operation, the station owner wishes to guide the operator (often called a picker or assembler) through one or more steps where a quantity of items are removed from (or put into) the boxes labeled 16, 18 and 20, for example, based upon the indication(s) provided by their associated modules 10, 12 and 14. A number of different sequences or operations (recipes) may be created and stored for later recall by the station owner. The ability for the station owner to create, store, and recall for use these sequences that define the operation of the modules using a spreadsheet program (such as Microsoft Excel or other known spreadsheet programs) is but one feature of the invention.

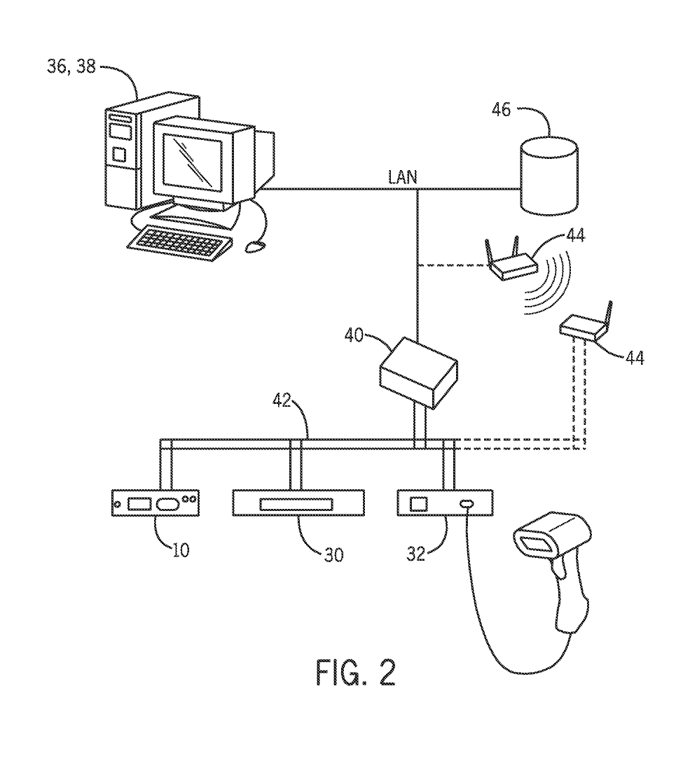

FIG. 2 provides a schematic representation of the modules shown in FIG. 1 along with representative interconnection interfaces and a computer 36 that may contain a computer program 38 that controls the pick/put system. The computer 36 is shown to be connected to the light modules 10 and 30 and other field equipment, such as bar code reader 32, by one or more interfaces 40. The interface(s) provides a path for commands to be conducted from the computer 36 to the modules and/or from the modules back to the computer. This path may be either via cabled 42 and/or wireless communications 44 known in the art. The spreadsheets that define the operation of the system, such as the sequence of steps, may be stored locally on the computer 38 or on some other computer or memory storage device, such as memory storage 46, for example, which is typically accessed via a Local Area Network (LAN).

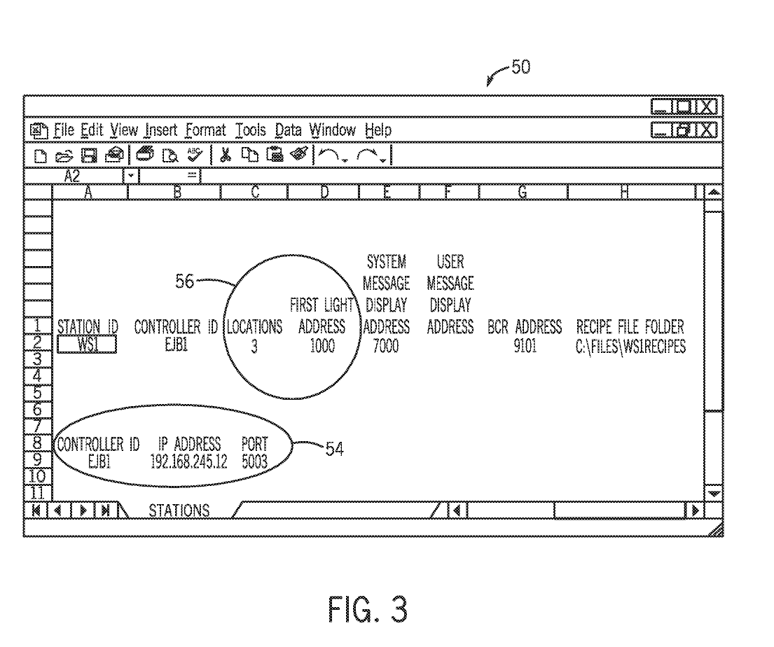

As previously noted, the invention allows the station owner to define a number of different module operations (sequence of steps or recipes) through the use of a spreadsheet program. Embodiments of the invention have been designed to operate with commercially available spreadsheet programs, such as Microsoft Excel, but could be adapted to alternative methods as well. In one embodiment, a configuration spreadsheet 50 shown in FIG. 3 may be used to define the electronic address of various modules and interface units. In the example shown in this figure, a single interface named EJB1 is specified for a specific address on the local area network 54. The individual module addresses, which will be available to be included in the recipe, are specified as to their number and their initial starting address 56. This configuration spreadsheet contains additional information specifying the address of additional modules, such as the message display (shown in FIG. 2 as item 30) and bar code interface (shown in FIG. 2 as item 32) as well as the location where the recipe(s) created using this system are to be stored. This example shows a simple system where a single workstation WS1 with only one interface and a small number of light modules are configured. The system has the capability to support many workstations with any number of modules. Additional workstations are configured by simply adding rows to the configuration spreadsheet and filling in the information specified by the columns.

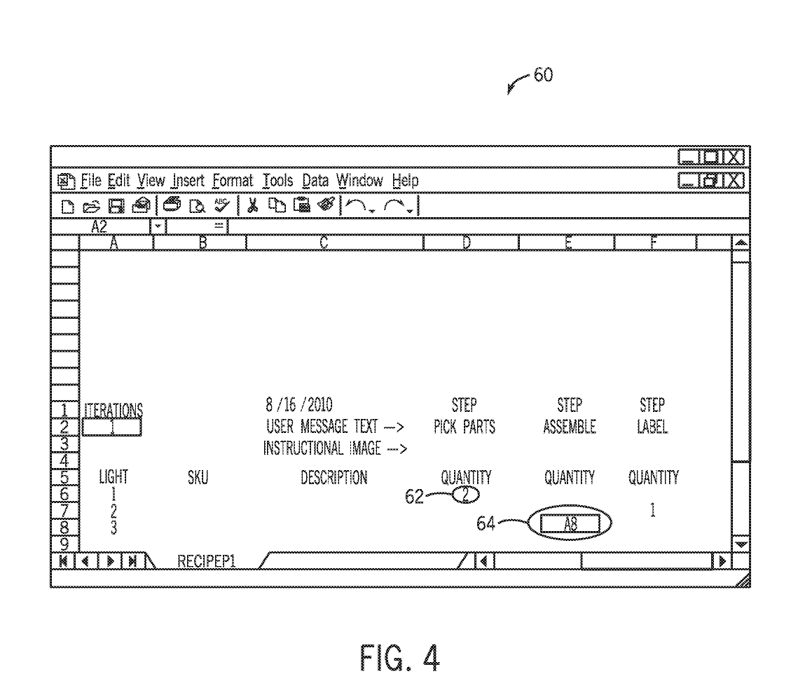

The configuration spreadsheet 50 of FIG. 3 and the recipe spreadsheet 60 of FIG. 4 include a variety of column heading names. The names of each heading are for example purposes only. The computer program (discussed below) will expect specific information in specific cells without regard to the heading name. It is to be appreciated that the information shown in FIG. 3 and FIG. 4 may be broken up between one or more “tabs” or “sheets” of the configuration spreadsheet.

The following headings shown in FIG. 3 are described below.

Controller ID: This is a user defined name for the controller.

IP address and Port: This is standard nomenclature to specify an address on a network, such as an Ethernet network.

Station ID: Each station typically has all the components it needs to run a recipe. It may include a bar code reader, one or more component locations, one or more message displays, and a disk file location (called a path) where the recipes are stored. In a typical system, the station owner could have a number of stations, each with a different bar code reader, different number of modules etc. The Station ID is a user defined name for each station.

Controller ID: Here the station owner re-uses the name that was previously given to the controller (see above) to tell the system which controller is used to access the modules that follow.

Locations: This is the number of module locations in this station. When combined with the First Light Address, the computer program can calculate the addresses of all the modules. In this example, 1000 is the first address followed by 1001 and 1002 for a total of three addresses. By way of example, when the recipe calls for a value to appear for the third light, it routes the message thru IP 192.168.245.12 Port 5003 Address 1002.

System Message Display Address: This is the address of the module that will display the step number. Step 1 of 3, Step 2 of 3 etc.

User Message Display Address: This is the address of the module that will display the User Message Text in the recipe.

Recipe File Folder: The recipes that are created, as shown in FIG. 4, may be stored electronically somewhere on the computer network. This is a standard Windows path that tells the computer program where to look for the recipe name when it is called for by this station.

FIG. 4 shows an exemplary completed recipe 60 that could apply to the modules shown in FIG. 1. The rows listed under the heading “Light” refer to the modules locations 1 through 3 shown on the configuration sheet of FIG. 3. The columns labeled “Step” allow the station owner to specify which modules are to be active in any step of the recipe. For example, reference 62 of FIG. 4 shows that Light module 1 is to be ON in step 1 and the module is to display the number 2. Reference 64 of FIG. 4 shows that, in step 2, Light module 3 is to be ON and the module is to display the value “A 8.” In one embodiment, colors and/or patterns, or other indications, may be used in the recipe spreadsheet to aid the programmer (station owner) in preparing the recipe so as to provide an indication of the actual module status. For example, a green color of the A 8 square may indicate that the light on the light module will be green in this step. This recipe is shown to contain additional information that may be shown on a message display module. The station owner configuring the recipe may then save the recipe under a name used to reference it. This name should match a bar code used to recall the recipe when the operator wishes to start the recipe at the workstation.

The following headings shown in FIG. 4 are described below.

Iterations: Recipes are configured to run a fixed number of times each time they are initiated, e.g., scanned. Typically it would be once (as shown in FIG. 4) but it is contemplated that it may be set for something else (say 5, for example). If it was set for 5, the complete 3 step sequence would execute 5 times in a row each time it was initiated.

Step: Everything listed in the first step column will come on when the first step in initiated. In some embodiments, all lights (or actions) shown on in the first step must be completed (confirmed) before the system will move to the second step. Initiation of the second step will show all items shown in that column. The station owner can define as many columns (steps) as he wishes. When the system completes the last step defined in the recipe, the system knows the recipe is complete.

System Message Text: Assuming that the workstation has a User Message Display defined, this is what the display will show in a given step.

Instructional Image: The system has the ability to display a picture on the PC monitor associated with a given step. If that was desired, the file name and Windows path of that image would be written here.

Light: Light numbers are sequential as shown in FIG. 3. The rows (light) and the columns (step) show what will be displayed on a given module in a given step.

SKU: This field allows the station owner to further document the recipe by naming the SKU that is stored in the box to which this module refers (see FIG. 1). SKU stands for Stock Keeping Unit which is common terminology in the industry for a name or part number.

Description: This field allows the station owner to further document the recipe by describing the item stored in the box to which this module refers (see FIG. 1)

Quantity: This field specifies what will appear on the modules (lights) in any give step. This does not have to be a number. The module will attempt to display whatever is in this cell. As an example, a field name such as “Display” may be used instead of Quantity. In one embodiment, the computer program is adapted to read various attributes of the data (i.e., a number or text) in each cell to determine characteristics with which the data is displayed on the module. As non-limiting examples, italics may cause the characters to flash, underscore may cause the light to flash, the background color of the cell may cause different colors to be displayed on the module button (light), etc.

In the embodiments described, the system owner would create a number of recipes in a similar format to that shown in FIGS. 3 and 4. In this embodiment, the owner is able to utilize the editing properties within the spreadsheet program to add steps, copy data from cell to cell, and alter cell data. As additional spreadsheets are created in this manor for later use, they may be encoded on a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like. In certain embodiments, these recipes may reside in computer readable medium within the computer which is local and closely associated with the station components shown in FIG. 2. In other embodiments, these recipes may reside in computer readable medium that is remote to the station components but accessible by the computer associated with the station components.

The embodiments described utilize a computer program 38 running in the computer 36 (FIG. 2) to interpret the configuration and recipe spreadsheets (FIGS. 3 and 4). The computer program 38 utilizes the data which is read from a recipe spreadsheet that has been activated to control the light module devices in a work cell 8 (FIG. 1). In one embodiment the program controls only a single work station with only a single recipe spreadsheet active at one time. However alternative embodiments allow the computer program to control many workstations at one time through many interfaces 40 (FIG. 2) with recipe spreadsheets read from any number of electronic storage media and each workstation having one recipe spreadsheet active so that many recipe spreadsheets are active in the system simultaneously.

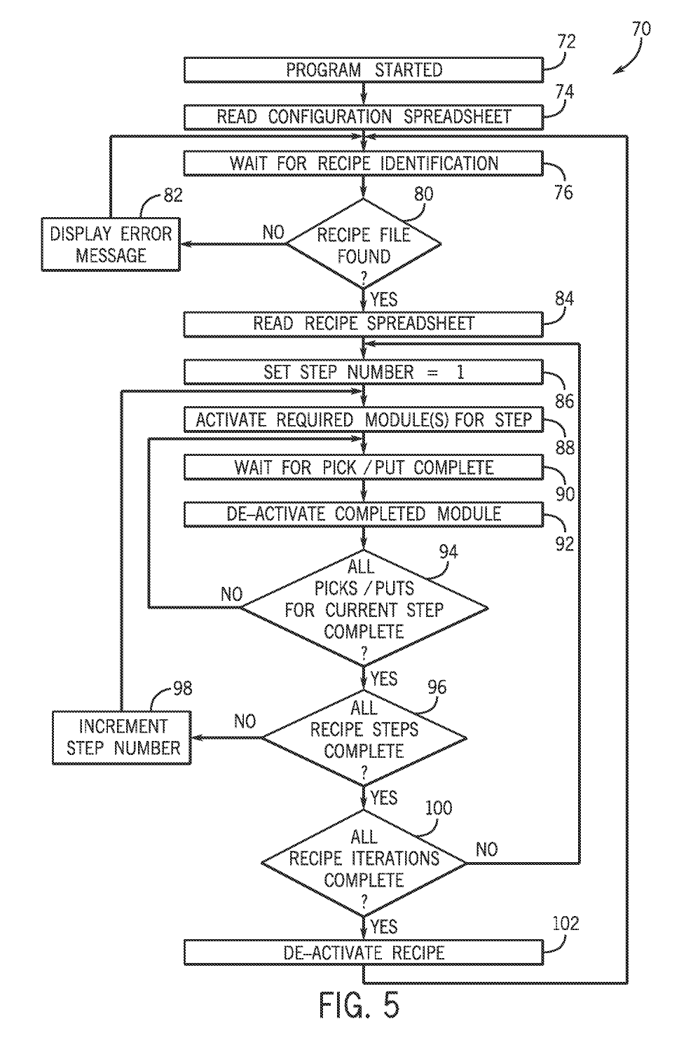

FIG. 5 shows an embodiment of a design flow chart method 70 that the computer program 38 described above may use to cause the light modules under its control to display and respond in the manor contained within the spreadsheet recipe. In each flow chart block, the computer program is designed to communicate with the necessary field devices with addresses contained within the associated spreadsheet, such as the light modules and displays shown in FIG. 1, as well as the bar code reader or other input device(s) shown in FIG. 1. The FIG. 5 flow chart shows only the most elemental steps for operation. The program is started at process block 72. The configuration spreadsheet 50 is read at process block 74. The system waits for input of a recipe number at process block 76. When a recipe number is input, at decision block 80, the program attempts to match it to a recipe file name previously stored. If the recipe is not found, an error message may be displayed at process block 82, and the method may return to process block 76 to wait for input of a recipe number. If the recipe is found, the recipe is read at process block 84, and the step number is set to one at process block 86. At process block 88, the required module(s) as called for in the first step column of the recipe are activated, and at process block 90 the method waits until the pick/put operation at each activated module is complete. At process block 92, the completed module is de-activated. If all the modules in the current step are not complete as required at decision block 94, the method returns to process block 90 for additional operations to be completed. If all the activated modules for the current step are complete, the method determines if all the recipe steps are complete, as indicated at decision block 96. If not, the step number is incremented at process block 98 and the method returns to process block 88 to activate additional modules. If all the recipe steps are complete, the method determines if all recipe iterations are complete, as shown at decision block 100. If not, the method returns to process block 86 for a new iteration, and if the iterations are complete, the recipe is de-activated at process block 102 and returns to process block 76 to wait for recipe number input.

In other embodiments the program may be expanded to allow for the implementation of diagnostic sub-programs and/or the addition of other graphical display devices. Where feedback is requested it is normally achieved when the button on a light module is pushed. However, it can be achieved through a variety of other means, such as a photo sensor associated with a light module (shown in FIG. 1 as Item 3), as a non-limiting example. In other embodiments, the program may be expanded to allow detection of user contact with modules or devices who's feedback is not expected or called for. Such uses may generate alarms or other operator notification.

The foregoing has been a detailed description of illustrative embodiments of the invention. Various modifications and additions can be made without departing from the spirit and scope thereof. Furthermore, since numerous modifications and changes will readily occur to those skilled in the art, it is not desired to limit the invention to the exact construction and operation shown and described. For example, any of the various features described herein can be combined with some or all of the other features described herein according to alternate embodiments. While the preferred embodiment has been described, the details may be changed without departing from the invention, which is defined by the claims.

Finally, it is expressly contemplated that any of the processes or steps described herein may be combined, eliminated, or reordered. In other embodiments, instructions may reside in computer readable medium wherein those instructions are executed by a processor to perform one or more of processes or steps described herein. As such, it is expressly contemplated that any of the processes or steps described herein can be implemented as hardware, software, including program instructions executing on a computer, or a combination of hardware and software. Accordingly, this description is meant to be taken only by way of example, and not to otherwise limit the scope of this invention.

We claim:

1. A system comprising:
a computer program stored in a computer memory, the computer program adapted to control one or more modules of a pick/put system by interpreting data stored in a spreadsheet, the data stored in the spreadsheet indicating a sequence of steps associated with the one or more modules of the pick/put system.

2. The system according to claim 1:
wherein the one or more modules are adapted to be controlled by the computer program as indicated by the data stored in the spreadsheet.

3. The system according to claim 1:
wherein the one or more modules may comprise one or more of an indicator light, a push button, a display, a bar code reader, a speaker, and a photo sensor.

4. The system according to claim 1:
wherein the spreadsheet is configured to define an electronic address for each of the one or more modules of the pick/put system.

5. The system according to claim 1:
wherein the computer program is adapted to reinterpret the data stored in the spreadsheet each time a workstation starts the spreadsheet.

6. The system according to claim 5:
wherein the spreadsheet comprises a recipe spreadsheet.

7. The system according to claim 6:
wherein the workstation starts the recipe spreadsheet by scanning a bar code.

8. The system according to claim 6:
further including a configuration spreadsheet.

9. The system according to claim 1:
wherein the computer program is adapted to interpret feedback received from the one or more modules during processing of the sequence of steps.

10. An arrangement comprising:
at least one pick/put system module associated with at least one physical location;
a computer running a spreadsheet program, the spreadsheet program including a configuration data set and a recipe data set, the computer also running a control program, the control program adapted to interpret the configuration data set and the recipe data set to control the at least one pick/put system module; and
a network to couple the at least one pick/put system module to the computer.

11. A method comprising:
inputting data into a spreadsheet program to create a recipe spreadsheet;
providing a computer program stored on a computer, the computer program adapted to interpret the recipe spreadsheet;
saving the recipe spreadsheet in memory;
initiating the computer program to interpret the recipe spreadsheet; and
controlling a pick/put system based on interpreting the recipe spreadsheet.

12. The method according to claim 11:
further including storing the saved recipe spreadsheet on the computer.

13. The method according to claim 11:
wherein the spreadsheet program is a commercially available spreadsheet program.

14. The method according to claim 11:
wherein inputting data into the recipe spreadsheet includes inputting a heading name in a first cell, and inputting operating data in a second cell, the operating data in the second cell associated with the heading name in the first cell.

15. The method according to claim 11:
wherein inputting data into the recipe spreadsheet includes inputting the data in a predetermined organized manner where the data includes a heading name and associated operating data.

16. The method according to claim 14:
further including using the computer program i) for recognizing the position of the cells in the recipe spreadsheet, and ii) for using the operating data from the cells to control the pick/put system.

17. The method according to claim 11:
further including providing at least one pick/put system module.

18. The method according to claim 17:
wherein the computer program operates the pick/put system by controlling a function of the at least one pick/put system module based on interpreting the data in the recipe spreadsheet.

19. The method according to claim 11:
wherein the computer program operates multiple workstations with multiple recipe spreadsheets active simultaneously.

20. The method according to claim 11:
wherein the computer program adds additional functions to provide additional functionality associated with the light modules.
